(19) United States
(12) Patent Application Publication
(10) Pub. No.: US 2012/0047464 A1
(43) Pub. Date: Feb. 23, 2012

(54) ELECTRONIC DEVICE AND METHOD FOR MANAGING USER INTERFACE OF THE ELECTRONIC DEVICE

(75) Inventor: CHENG-HAN LIU, Tu-Cheng (TW)

(73) Assignee: HON HAI PRECISION INDUSTRY CO., LTD., Tu-Cheng (TW)

(21) Appl. No.: 12/961,888

(22) Filed: Dec. 7, 2010

(30) Foreign Application Priority Data
Aug. 20, 2010 (CN) 201010258883.8

(51) Int. Cl. G06F 3/048; G09G 5/00

(52) U.S. Cl. 715/836; 345/156

(57) ABSTRACT

An electronic device and a method for managing a user interface include setting a movement speed of the interface elements in the user interface corresponding to an angle of change of the electronic device, and setting a movement direction of the interface elements in the user interface corresponding to rotation direction. The method further includes confirming the movement speed and the movement direction of the interface elements in the user interface according to the angle of change and the rotation direction, and controlling the interface elements in the user interface to according to the confirmed movement speed and movement direction.

### BACKGROUND

1. Technical Field

Embodiments of the present disclosure relate to user interface management, and in particular, to an electronic device and method for managing a user interface of the electronic device.

2. Description of Related Art

People may have to click on many menus and submenu items of a user interface of an electronic device to navigate to a desired target program of the electronic device. Generally, a menu may include a plurality of submenus, and submenus may include a plurality of items. People need to click one menu to see its submenus. Therefore, people cannot conveniently know what submenus that the menu includes. If people do not know that the target program belongs to which menu or submenu, people may be confused which causes unneeded and unwanted clicking. Accordingly, time is wasted, and a touch screen of the electronic device may be worn out sooner.

### BRIEF DESCRIPTION OF THE DRAWINGS

FIG. 1 is a block diagram of one embodiment of an electronic device including a management system.

FIG. 2 is a schematic diagram of one embodiment of a plurality of three-dimensional menus and a display showing one three-dimensional menu.

FIG. 3 is a block diagram of one embodiment of the management system of FIG. 1.

FIG. 4 is a schematic diagram of one embodiment of a predetermined reference orientation of an electronic device, such as, for example, that of FIG. 1.

FIG. 5A-B are schematic diagrams of one embodiment of angle of changes between the electronic device and the reference orientation of FIG. 4.

FIG. 6 is a flowchart of one embodiment of a method for managing a user interface of an electronic device, such as, for example, that of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage system.

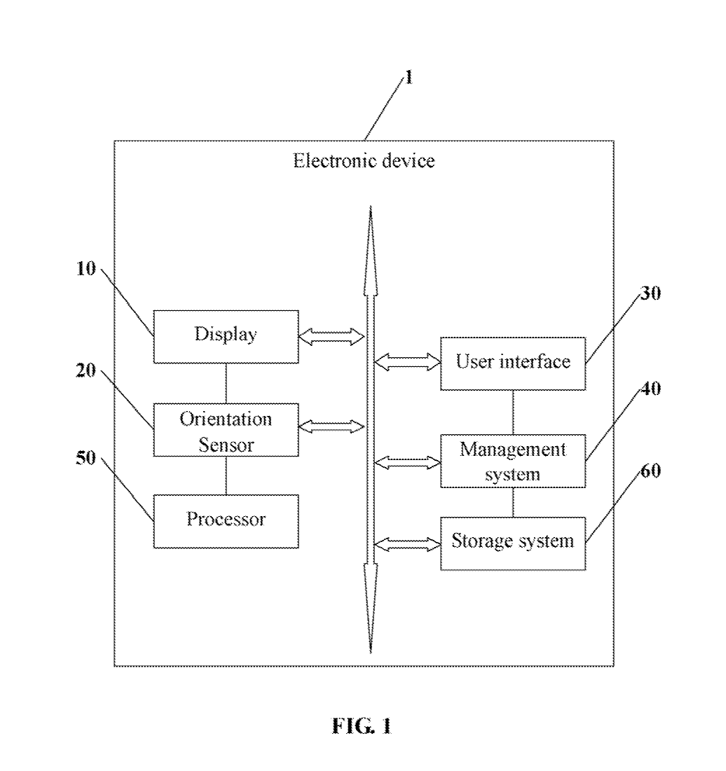

FIG. 1 is a block diagram of one embodiment of an electronic device 1 including a management system 40. The electronic device 1 further includes a display 10, an orientation sensor 20, and a user interface 30. The user interface 30 may be shown on the display 10. The orientation sensor 20 may monitor an angle of change and a rotation direction of the electronic device 1. In some embodiments, the orientation sensor 20 may be an accelerometer or a gyroscope, for example. The management system 40 may control the user interface 30 to move according to a movement speed and a movement direction corresponding to the angle of change and the rotation direction of the electronic device 1.

Interface elements in the user interface 30 include a plurality of three-dimensional (3D) menus (or lists), and 3D submenus of each of the 3D menus. The 3D submenus may be cascaded under corresponding 3D menus. In some embodiments, the 3D menus may be displayed side by side. If the submenus include a plurality of items, the user interface 30 further includes 3D submenus displaying side by side, and the items of each 3D submenu may be 3D and cascaded under corresponding 3D submenus. The interface elements can further include other graphical user elements of the electronic device 1.

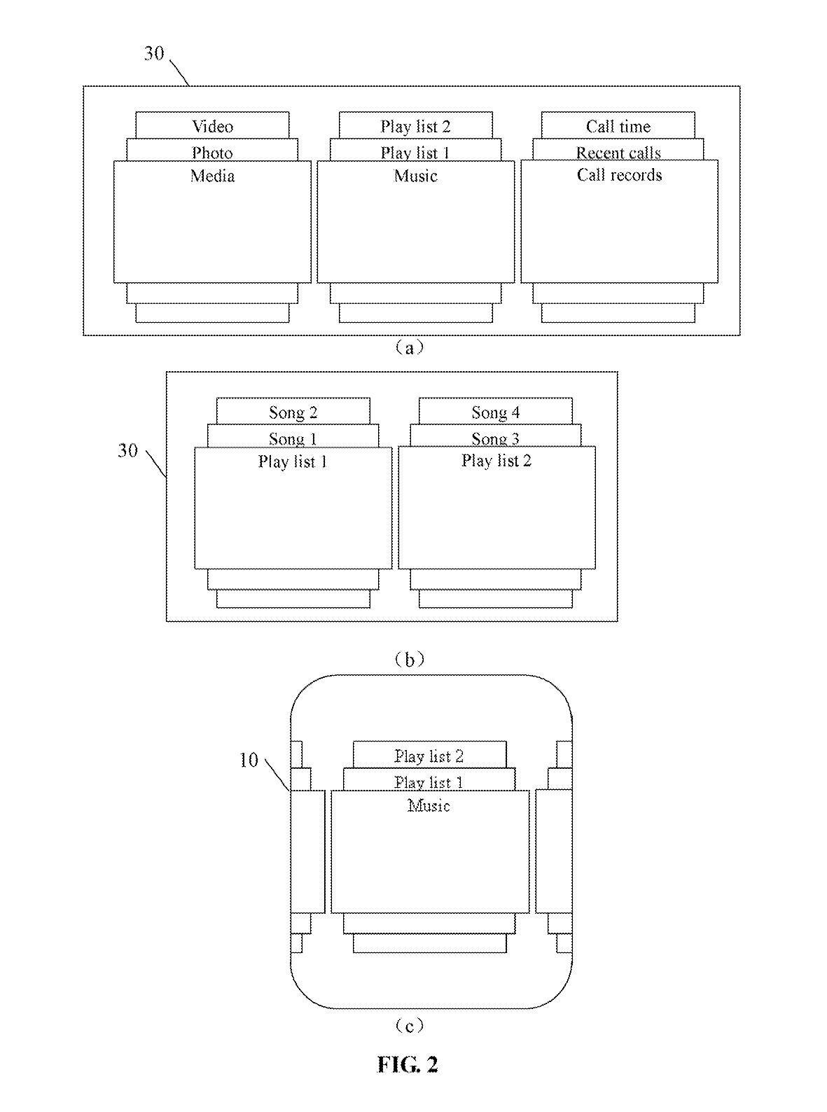

As shown in FIG. 2, a schematic diagram of one embodiment of a plurality of 3D menus. In FIG. 2 (a), the interface elements in the user interface 30 includes a 3D “media” menu, a 3D “music” menu and a 3D “call records” menu displayed side by side. 3D submenus of each 3D menu are cascaded under corresponding 3D menus. The word “cascaded” means one submenu over one submenu layer by layer. For example, a “photo” menu and a “video” menu are cascaded under the corresponding “media” menu. In FIG. 2 (b), when the “music” menu is activated or chosen, a “play list 1” submenu and a “play list 2” submenu of the 3D “music” menu may be displayed side by side. Items “song 1” and “song 2” of the “play list 1” submenu may be cascaded under the “play list 1” submenu, and items “song 3” and “song 4” of “the play list 2” submenu may be cascaded under the “play list 2” submenu. In FIG. 2 (c), when the user interface 30 shows on the display 10, the display 10 may show one 3D menu entirely, and show only portions of other adjacent 3D menus.

The electronic device 1 further includes a storage system 50 and a processor 60. The storage system 50 may be a memory system of the electronic device 1, or may be an external storage card, such as a smart media (SM) card, or a secure digital (SD) card, for example. The processor 60 executes one or more computerized code of the electronic device 1 and other applications, to provide the functions of the electronic device 1.

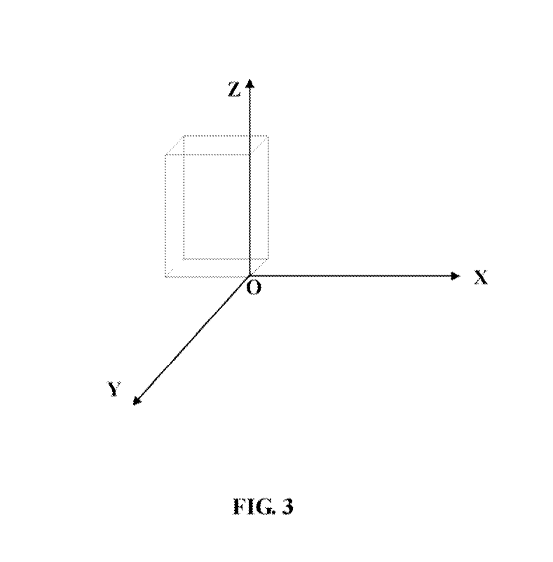

FIG. 3 is a block diagram of one embodiment of the management system of FIG. 1. In some embodiments, the management system 40 includes a showing module 400, a setting module 402, an acquisition module 404, a confirmation module 406, and a control module 408. The modules 400, 402, 404, 406 and 408 may comprise computerized code in the form of one or more programs that are stored in the storage system 50. The computerized code includes instructions that are executed by the at least one processor 60 to provide functions for modules 400, 402, 404, 406 and 408. Details of these operations follow.

The showing module 400 shows the user interface 30 on the display 10. The interface elements in the user interface 30 includes a plurality of 3D menus (or lists), and 3D submenus of each of the 3D menus. The 3D submenus may be cascaded under corresponding 3D menus. Navigation to any menu or submenu can be accomplished by rotating the electronic device 1 to bring a desired menu or submenu to a dominant position in the interface 30. “Rotation” herein may include movements of the electronic device 1 away from a reference orientation and movements in return to approximate the reference orientation.

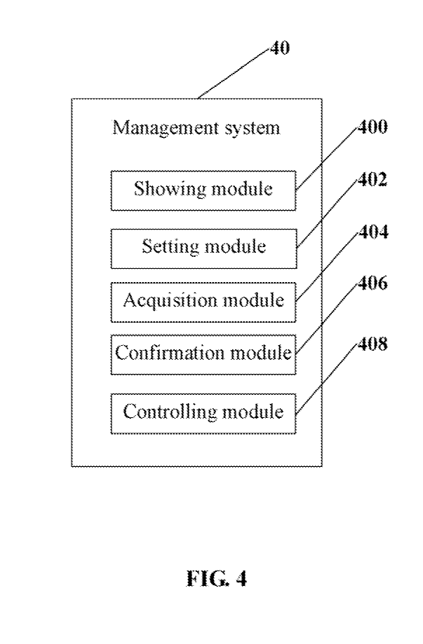

The setting module 402 can set a current orientation of the electronic device 1 to be a reference orientation, according to user preference. The setting module 402 may preset a hotkey of the electronic device 1 to set the current orientation. If the hotkey is triggered, the setting module 402 may set the current orientation of the electronic device 1 to be the reference orientation. FIG. 4 is a schematic diagram of one embodiment of the reference orientation of the electronic device 1. Directions of movement of the electronic device 1 are determined according to a 3D coordinate system OXYZ. The display 10 is in a XOZ plane. The reference orientation is defined by setting a point in the lower right corner of the display 10 as an origin, a horizontal direction of the display 10 as an x-axis, a vertical direction of the display 10 as a z-axis, and a direction perpendicular to the display 10 as a y-axis.

The setting module 402 sets a movement speed of the interface elements in the user interface 30 of the electronic device 1 during navigation, the movement speeds respectively correspond to changes in angle of the electronic device 1 relative to the reference orientation of the electronic device 1. The movement speed may be represented with pixels. For example, the movement speed of the interface elements in the user interface 30 can be 10 pixels per second. In some embodiments, the setting module 402 may set the movement speed to 0 pixels per second if the angle of change is within a range of [0 degrees, 10 degrees], that is, the interface elements in the user interface 30 may not move. The setting module 402 may set the movement speed to 10 pixels per second if the angle of change is within a range of [11 degrees, 45 degrees]. During navigation of menus and submenus, if a user tilts the electronic device 1 away from the reference orientation, navigational movement of the menus in the display 10 will occur and continue until the electronic device 1 returns to reference orientation, and the speed of navigational movement of the menus will accord with the degree of tilt.

The setting module 402 further sets a movement direction of the interface elements in the user interface 30 corresponding to each rotation direction of the electronic device 1, according to the reference orientation of the electronic device 1. In some embodiments, the movement directions may include up, down, left and right. If the electronic device 1 rotates from the reference orientation to a positive direction of the y-axis anticlockwise, the setting module 402 sets the movement direction of the interface elements in the user interface 30 to be a down direction. If the electronic device 1 rotates from the reference orientation to a negative direction of the y-axis clockwise, the setting module 402 sets the movement direction to be an up direction. If the electronic device 1 rotates from the reference orientation to a positive direction of the x-axis clockwise, the setting module 402 sets the movement direction to be a right direction. If the electronic device 1 rotates from the reference orientation to a negative direction of the y-axis anticlockwise, the setting module 402 sets the movement direction to be a left direction.

The acquisition module 406 acquires the angle of change and the rotation direction of the electronic device 1 from the orientation sensor 20. The orientation sensor 20 monitors the angle of change and the rotation direction according to the reference orientation of the electronic device 1.

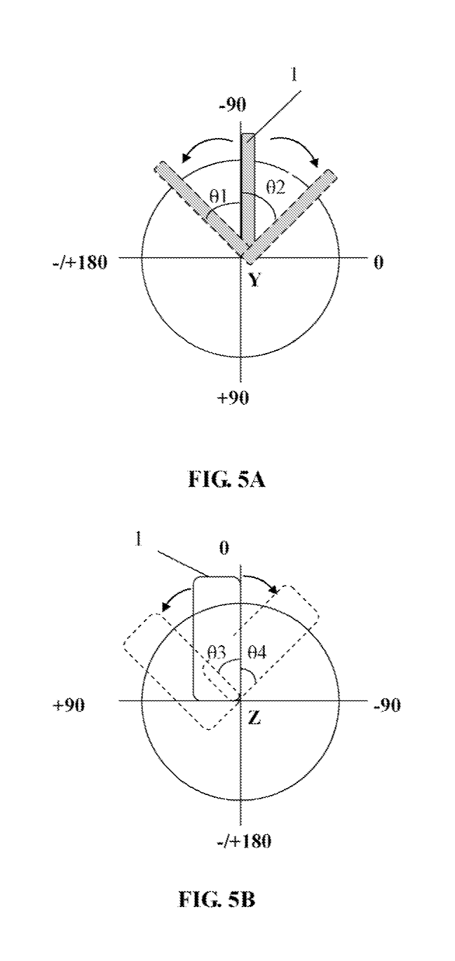

The confirmation module 408 confirms the movement speed and the movement direction of the electronic device 1 according to the acquired angle of change and rotation direction. FIG. 5A-B are schematic diagrams of one embodiment of angle of changes between the electronic device and the reference orientation of FIG. 4. The electronic device 1 is in a vertical position, and the display 10 faces to the users. FIG. 5A is the schematic diagram of the angle of changes between the electronic device 1 and the y-axis of the reference orientation in a YOZ plane. If the electronic device 1 rotates towards the users, and the acquisition module 406 acquires the angle of change (“θ2” as shown in FIG. 5A), the confirmation module 408 may confirm that the movement direction is down, and confirm the movement speed corresponding to the θ2. If the electronic device 1 rotates away from the users, and the acquisition module 406 acquires the angle of change (“θ1” as shown in FIG. 5A), the confirmation module 408 may confirm that the movement direction is up, and confirm the movement speed corresponding to the θ1.

FIG. 5B is the schematic diagram of the angle of changes between the electronic device 1 and the z-axis of the reference orientation in the XOZ plane. If the electronic device 1 rotates to right, and the acquisition module 406 acquires the angle of change (“θ4” as shown in FIG. 5B), the confirmation module 408 may confirm that the movement direction is right, and confirm the movement speed corresponding to the θ4. If the electronic device 1 rotates to left, and the acquisition module 406 acquires the angle of change (“θ3” as shown in FIG. 5B), the confirmation module 408 may confirm that the movement direction is left, and confirm the movement speed corresponding to the θ3.

In some embodiments, if the acquisition module 406 acquires a angle of change between the electronic device 1 and the y-axis, and a angle of change between the electronic device 1 and the z-axis, the confirmation module 408 may confirm the movement direction and the movement speed according to the bigger angle of change. For example, if the angle of change between the electronic device 1 and the y-axis is eighty degrees, and the angle of change between the electronic device 1 and the z-axis is five degrees, the confirmation module 408 may confirm the movement direction and the movement speed according to the 80 degrees.

The controlling module 410 controls the interface elements of the user interface 30 to according to the confirmed movement speed and towards the confirmed movement direction.

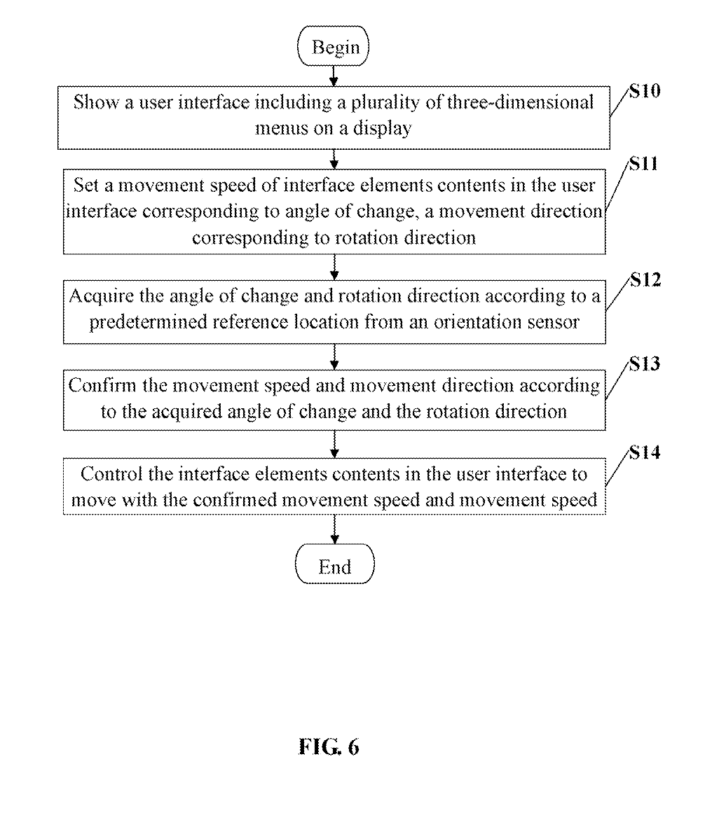

FIG. 6 is a flowchart of one embodiment of a method for managing the user interface 30 in the electronic device 1. Depending on the embodiment, additional blocks may be added, others removed, and the ordering of the blocks may be changed.

In block S10, the showing module 400 shows the user interface 30 on the display 10. The user interface 30 includes a plurality of 3D menus (or lists), and 3D submenus of each of the 3D menus. The 3D submenus may be cascading under corresponding 3D menus.

In block S11, the setting module 402 sets the current orientation of the electronic device 1 to be the reference orientation, sets a movement speed of the interface elements in the user interface 30 corresponding to changes in an angle of the electronic device 1 relative to the reference orientation, and sets a movement direction of the interface elements in the user interface 30 corresponding to rotation direction of the electronic device 1 relative to the reference orientation.

In block S12, the acquisition module 406 acquires the angle of change and the rotation direction of the electronic device 1 from the orientation sensor 20. The orientation sensor 20 monitors changes in angle and rotation direction relative to the reference orientation of the electronic device 1.

In block S13, the confirmation module 408 confirms the movement speed and the movement direction according to the acquired angle of change and rotation direction.

In block S14, the controlling module 410 controls the interface elements in the user interface 30 to according to the confirmed movement speed and in the confirmed movement direction.

It should be emphasized that the described inventive embodiments are merely possible examples of implementations, and set forth for a clear understanding of the principles of the present disclosure. Many variations and modifications may be made to the-described inventive embodiments without departing substantially from the spirit and principles of the present disclosure. All such modifications and variations are intended to be comprised herein within the scope of this disclosure and the-described inventive embodiments, and the present disclosure is protected by the following claims.

What is claimed is:

1. An electronic device, comprising:
a storage system;
a display to show a user interface of the electronic device;
an orientation sensor;
at least one processor; and
one or more programs stored in the storage system, executable by the at least one processor, the one or more programs comprising:
a setting module operable to set a movement speed of interface elements of the user interface, the movement speed corresponding to an angle of change of the electronic device, and set a movement direction of the interface elements of the user interface corresponding to rotation direction of the electronic device;
an acquisition module operable to acquire the angle of change and the rotation direction of the electronic device from the orientation sensor;
a confirmation module operable to confirm the movement speed and the movement direction according to the acquired angle of change and rotation direction; and
a controlling module operable to control the interface elements in the user interface to move according to the confirmed movement speed and movement direction.

2. The electronic device as claimed in claim 1, wherein the interface elements in the user interface comprise a plurality of three-dimensional (3D) menus, and 3D submenus of each of the 3D menus, the 3D submenus being 3D cascading under corresponding 3D menus.

3. The electronic device as claimed in claim 1, wherein the orientation sensor monitors the angle of change and the rotation direction according to a predetermined reference orientation of the electronic device, and wherein a current orientation of the electronic device is user-changeable.

4. The electronic device as claimed in claim 3, wherein the predetermined reference orientation of the electronic device is defined by setting a vertex of right corner of the display as an origin, a horizontal direction of the display as an x-axis, a vertical direction of the display as a z-axis, and a direction perpendicular to the display as a y-axis.

5. The electronic device as claimed in claim 4, wherein the controlling module is further operable to:
control the interface elements in the user interface to move down, in response that the electronic device rotates from the predetermined reference orientation to a positive direction of the y-axis anticlockwise; or
control the interface elements in the user interface to move up, in response that the electronic device rotates from the predetermined reference orientation to a negative direction of the y-axis clockwise.

6. The electronic device as claimed in claim 4, wherein the controlling module is further operable to:
control the interface elements in the user interface to move right, in response that the electronic device rotates from the predetermined reference orientation to a positive direction of the x-axis clockwise; or
control the interface elements in the user interface to move left, in response that the electronic device rotates from the predetermined reference orientation to a negative direction of the y-axis anticlockwise.

7. A computer-implemented method for managing a user interface of an electronic device, the electronic device comprising an orientation sensor, the method comprising:
setting a movement speed of interface elements in a user interface of the electronic device, the movement speed corresponding to an angle of change of the electronic device, and setting a movement direction of the interface elements in the user interface corresponding to rotation direction of the electronic device;
acquiring the angle of change and the rotation direction of the electronic device from the orientation sensor;
confirming the movement speed and the movement direction of the interface elements in the user interface according to the acquired angle of change and rotation direction;
controlling the interface elements in the user interface to move according to the confirmed movement speed and movement direction.

8. The method as claimed in claim 7, wherein the interface elements in the user interface comprise a plurality of three-dimensional (3D) menus, and 3D submenus of each of the 3D menus, the 3D submenus being 3D cascading under corresponding 3D menus.

9. The method as claimed in claim 7, wherein the orientation sensor monitors the angle of change and the rotation direction according to a predetermined reference orientation of the electronic device, and wherein a current orientation of the electronic device is user-changeable.

10. The method as claimed in claim 9, wherein the predetermined reference orientation of the electronic device is defined by setting a vertex of right corner of the display as an origin, a horizontal direction of the display as an x-axis, a vertical direction of the display as a z-axis, and a direction perpendicular to the display as a y-axis.

11. The method as claimed in claim 10, further comprising:
controlling the interface elements in the user interface to move down, in response that the electronic device rotates from the predetermined reference orientation to a positive direction of the y-axis anticlockwise; or
controlling the interface elements in the user interface to move up, in response that the electronic device rotates from the predetermined reference orientation to a negative direction of the y-axis clockwise.

12. The method as claimed in claim 10, further comprising:
controlling the interface elements in the user interface to move right, in response that the electronic device rotates from the predetermined reference orientation to a positive direction of the x-axis clockwise; or
controlling the interface elements in the user interface to move left, in response that the electronic device rotates from the predetermined reference orientation to a negative direction of the y-axis anticlockwise.

13. A storage medium storing a set of instructions, the set of instructions capable of executed by a processor to perform a method for managing a user interface of an electronic device, the electronic device comprising an orientation sensor, the method comprising:
setting a movement speed of interface elements in a user interface of the electronic device, the movement speed corresponding to an angle of change of the electronic device, and setting a movement direction of the interface elements in the user interface corresponding to rotation direction of the electronic device;
acquiring the angle of change and the rotation direction of the electronic device from the orientation sensor, the orientation sensor monitoring the angle of change and the rotation direction according to a predetermined reference orientation of the electronic device;
confirming the movement speed and the movement direction of the interface elements in the user interface according to the acquired angle of change and rotation direction;
controlling the interface elements in the user interface to move according to the confirmed movement speed and movement direction.

14. The storage medium as claimed in claim 13, wherein interface elements in the user interface comprise a plurality of three-dimensional (3D) menus, and 3D submenus of each of the 3D menus, the 3D submenus being 3D cascading under corresponding 3D menus.

15. The storage medium as claimed in claim 13, wherein the orientation sensor monitors the angle of change and the rotation direction according to a predetermined reference orientation of the electronic device, and a current orientation of the electronic device can be set to be the predetermined reference orientation according to preference.

16. The storage medium as claimed in claim 15, wherein the predetermined reference orientation of the electronic device is defined by setting a vertex of right corner of the display as an origin, a horizontal direction of the display as an x-axis, a vertical direction of the display as a z-axis, and a direction perpendicular to the display as a y-axis.

17. The storage medium as claimed in claim 16, further comprising:
controlling the interface elements in the user interface to move down, in response that the electronic device rotates from the predetermined reference orientation to a positive direction of the y-axis anticlockwise; or
controlling the interface elements in the user interface to move up, in response that the electronic device rotates from the predetermined reference orientation to a negative direction of the y-axis clockwise.

18. The storage medium as claimed in claim 16, further comprising:
controlling the interface elements in the user interface to move right, in response that the electronic device rotates from the predetermined reference orientation to a positive direction of the x-axis clockwise; or
controlling the interface elements in the user interface to move left, in response that the electronic device rotates from the predetermined reference orientation to a negative direction of the y-axis anticlockwise.
